(19) United States
(12) Patent Application Publication
(10) Pub. No.: US 2018/0272651 A1
(43) Pub. Date: Sep. 27, 2018

(54) RESIN MOLDING AND MANUFACTURING METHOD THEREFOR

(71) Applicant: MAZDA MOTOR CORPORATION, Hiroshima (JP)

(72) Inventor: Yohei ICHIHARA, Hiroshima-shi, Hiroshima (JP)

(73) Assignee: MAZDA MOTOR CORPORATION, Hiroshima (JP)

(21) Appl. No.: 15/763,059

(22) PCT Filed: Oct. 24, 2016
(86) PCT No.: PCT/JP2016/081456

§ 371 Date: Mar. 23, 2018

(30) Foreign Application Priority Data
Oct. 27, 2015 (JP) 2015-211207

(51) Int. Cl. B32B 3/30; B29C 45/16; B32B 7/02; B32B 27/08; B29C 45/26

(52) U.S. Cl. CPC B32B 3/30; B29C 45/16; B29L 2009/00; B32B 27/08; B29C 45/26; B32B 7/02

(57) ABSTRACT

Regarding a resin molding including embossment 4 provided for an interface between a base 2 and a translucent surface layer 3, if a value Y-highlight designates a value Y of light which is incident at 45 degrees and detected at an acceptance angle of +30 degrees, and a value Y-shade designates a value Y of light which is incident at 45 degrees and detected at an acceptance angle of −30 degrees, the value Y-highlight and the value Y-shade being calibrated with a value Y of a white reflectance standard of an XYZ colorimetric system regarded as 100%, a difference between the value Y-highlight and the value Y-shade of a flat portion of a surface of the base material 2 is 5 or more, and the surface layer 3 has a total light transmittance of 2.5% or more and 60% or less.

### TECHNICAL FIELD

The present invention relates to a resin molding including a base material, a translucent surface layer which covers a surface of the base material, and embossment provided for an interface between the base material and the surface layer, and to a method for manufacturing the resin molding.

### BACKGROUND ART

Various products, such as interior and exterior materials of automobiles, household products, and office supplies, are molded from synthetic resin. Need for decoration of these synthetic resin moldings has recently been increasing. Patent Document 1, related to such decoration technologies, discloses a decorative film including a first transparent or opaque synthetic resin film and a second transparent synthetic resin film. The first synthetic resin film has a bright grained upper surface, on which the second synthetic resin film, which is made of a single layer or plural layers, is stacked.

Further, Patent Document 1 describes that: a synthetic resin kneaded with flakes or powder of a brightening material is used for the first synthetic resin; the synthetic resins forming the first and second synthetic resin films have melt flow rates different by 0.5 to 50 g/minute so as to avoid the grain from being spoiled through heating for stacking the second synthetic resin film on the first synthetic resin film; the two synthetic resin films may be colored; and due to the bright grained surface that reflects light well, the reflection of light and the shading vary depending on the viewing direction, which makes the product look more three-dimensional and classy.

### CITATION LIST

### Patent Documents

[Patent Document 1] Japanese Unexamined Patent Publication No. 2005-14374

### SUMMARY

### Technical Problem

In general, a resin molding having a base material, a translucent surface layer covering a surface of the base material, and embossment provided for an interface between the base material and the surface layer, such as the decorative panel described above, would be improved in design if the embossment at the interface can be seen through the surface layer. The present inventor has produced many prototypes by using various kinds of base material and surface layer to examine the visibility of the embossment. As a result, it has been revealed that the embossment, even if it is properly formed as intended, is poor in spatial depth (three-dimensional look) and shading.

In view of the foregoing background, it is therefore an object of the present invention to provide a resin molding including embossment provided for an interface between a base material and a translucent surface layer, in which the embossment can be seen with a greater spatial depth and shading.

### Solution to the Problem

To achieve the object, the present invention has been focused on a value Y (brightness) of a flat portion of a surface of the base material, and a total light transmittance of the surface layer.

The disclosed resin molding includes: a base material; and a translucent surface layer which covers a surface of the base material, wherein embossment is provided for an interface between the base material and the surface layer, if a value Y-highlight designates a value Y of light which is incident at 45 degrees and detected at an acceptance angle of +30 degrees, and a value Y-shade designates a value Y of light which is incident at 45 degrees and detected at an acceptance angle of −30 degrees, a difference between the value Y-highlight and the value Y-shade of a flat portion of the surface of the base material is 5 or more, and the surface layer has a total light transmittance of 2.5% or more and 60% or less.

In this specification, the value Y is a value calibrated with a value Y of a white reflectance standard of the XYZ colorimetric system regarded as 100%.

The value Y of the XYZ colorimetric system is a stimulus value indicating luminance (luminous reflectance). The feature that the difference between the value Y-highlight and the value Y-shade of the flat portion of the surface of the base material is 5 or more indicates that lightness greatly varies depending on the viewing angle. Thus, when the embossment at the interface of the resin molding is seen through the surface layer, recessed portions of the embossment shaded by protruding portions of the embossment become more shaded. The shading gives the embossment a greater spatial depth (three-dimensional look). As the light transmittance of the surface layer increases, a color depth and spatial depth of the surface layer decrease. On the other hand, the lower the light transmittance is, the harder it becomes to see the embossment through the surface layer. As a solution to such a disadvantage, the total light transmittance of the surface layer of the resin molding is set to be 2.5% or more and 60% or less.

The surface layer may be made of a single layer, or a stack of two or more layers.

Various kinds of resin material may be used for the base material and the surface layer. Suitable examples of the resin material for the base material include PC (polycarbonate), ABS resin, and PC-ABS (a polymer alloy of PC and ABS). Suitable examples of the resin material for the surface layer include PC, and PMMA (polymethylmethacrylate).

The difference between the value Y-highlight and the value Y-shade is preferably 10 or more, more preferably 15 or more. The difference between the values Y-highlight and Y-shade is preferably 400 or less. The total light transmittance is preferably 5% or more and 50% or less, more preferably 8% or more and 40% or less.

In one preferred embodiment, the embossment has an emboss height of 5 μm or more and 700 μm or less. If the emboss height is less than 5 μm, the embossment becomes less visible. The emboss height exceeding 700 μm is not recommended because such a height is disadvantageous for forming fine embossment. The emboss height is preferably 10 μm or more and 350 μm or less, more preferably 15 μm or more and 200 μm or less.

In one preferred embodiment, the surface layer has a thickness of 0.8 mm or more and 8 mm or less. If the thickness is less than 0.8 mm, the formation of the surface layer becomes difficult. If the thickness exceeds 8 mm, the surface of the surface layer may become less smooth.

In one preferred embodiment, the surface layer contains a coloring agent. Coloring the surface layer can easily improve the design. Examples of the coloring agent include inorganic pigments and dyes.

A method for manufacturing the disclosed resin molding includes: injecting a first resin material in a first molding cavity having a grained molding surface for forming the embossment, thereby forming one of the base material having the embossment corresponding to the grained surface or the surface layer having the embossment corresponding to the grained surface; forming a second molding cavity on a surface of the base material provided with the embossment or a surface of the surface layer provided with the embossment; and injecting a second resin material in the second molding cavity to form the other one of the base material or the surface layer.

In this case, any of co-injection molding (double molding) and insert molding may be adopted. In the co-injection molding, the base material and the surface layer are molded using a primary cavity mold and a secondary cavity mold provided for a single molding machine, and a common core mold selectively combined with one of the two cavity molds. In the insert molding, the base material is first injection-molded and the obtained base material is inserted in a surface layer molding die, and then the surface layer is injection-molded. Alternatively, the surface layer is first injection-molded and the obtained surface layer is inserted in a base material molding die, and then the base material is injection-molded.

In one preferred embodiment, the first resin material contains a brightening material and/or an inorganic pigment, and is injected in the first molding cavity to form the base material having on its surface the embossment corresponding to the grained surface, and the second resin material is injected in the second molding cavity to form the surface layer.

The first resin material contains a brightening material and/or an inorganic pigment, and thus, has a lower melt flow rate than a matrix resin thereof. This can advantageously avoid the second resin material, which is injected in and flows within the second molding cavity, from spoiling the embossment of the base material. Note that the second resin material is not necessarily a resin material which melts at a lower temperature than the matrix resin of the first resin material. This offers a wide choice of resin materials, and makes the invention more flexible.

To avoid the flowing second resin material from spoiling the embossment formed by the first resin material, a temperature for melting the first resin material is preferably higher, by 50° C. at the maximum, than a temperature for melting the second resin material. In other words, it is preferable that the first and second resin materials are molten at similar temperatures, or the temperature for melting the second resin material is lower than the temperature for melting the first resin material.

The brightening material may be, for example, aluminum flakes, and the inorganic pigment may be titanium, carbon, iron oxide, or any other suitable pigment.

If the base material is formed by injection molding the first resin material, the surface layer molded from the second resin material preferably has a thickness of 0.8 mm or more and 8 mm or less. If the thickness of the surface layer is less than 0.8 mm, the second resin material decreases in flowability, and causes increased shear stress. Thus, the embossment of the base material may be easily spoiled. If the thickness of the surface layer exceeds 8 mm, the surface of the surface layer may be easily corrugated due to molding shrinkage.

If the base material is formed by injection molding the first resin material, the embossment provided for the surface of the base material preferably has an emboss height of 700 μm or less. If the emboss height exceeds 700 μm, the second resin material receives a greater flow resistance from the embossment, which inevitably requires an increased injection pressure. As a result, the flow of the second resin material easily spoils the embossment. The embossment is easily spoiled especially around the injection gate. Further, if the embossment has regularity just like a mesh pattern, the embossment, if spoiled, becomes more conspicuous. The emboss height is preferably 350 μm or less, more preferably 200 μm or less.

### Advantages of the Invention

According to the present invention, a resin molding in which embossment is provided for an interface between a base material and a surface layer is provided so that a difference between a value Y-highlight and a value Y-shade of a flat portion of a surface of the base material is 5 or more, and the surface layer has a total light transmittance of 2.5% or more and 60% or less. Thus, the embossment can be clearly seen with great shading and spatial depth (three-dimensional look), which advantageously improves the design of the resin molding.

### BRIEF DESCRIPTION OF THE DRAWINGS

FIG. 1 is a perspective view illustrating a resin molding, partially in cross section.

FIG. 2 is a cross-sectional view schematically illustrating an example of an injection molding machine used for manufacturing the resin molding.

FIG. 3 illustrates how a value Y is measured.

FIG. 4 is a graph illustrating the value Y of a black base material with respect to an acceptance angle.

FIG. 5 is a graph illustrating the value Y of a white base material with respect to an acceptance angle.

FIG. 6 is a graph illustrating the value Y of a silver base material with respect to an acceptance angle.

FIG. 7 is a graph illustrating the value Y of a gunmetal base material with respect to an acceptance angle.

FIG. 8 is an image (photograph) of embossment seen through a surface layer of Sample 1 (base material: black, a difference between a value Y-highlight and a value Y-shade: 3.7).

FIG. 9 is an image (photograph) of embossment seen through a surface layer of Sample 2 (base material: white, a difference between the values Y-highlight and Y-shade: 3.7).

FIG. 10 is an image (photograph) of embossment seen through a surface layer of Sample 3 (base material: silver, a difference between the values Y-highlight and Y-shade: 175).

FIG. 11 is a graph illustrating spectral reflectance of Sample 1 (with a surface layer).

FIG. 12 is a graph illustrating spectral reflectance of Sample 2 (with a surface layer).

FIG. 13 is a graph illustrating spectral reflectance of Sample 3 (with a surface layer).

FIG. 14 is a graph illustrating a relationship between a value Y and an acceptance angle of Samples 1-3.

FIG. 15 is a graph comparing a value Y of a flat surface of a black base material, and a value Y of a woodgrain embossed surface of a black base material.

FIG. 16 is a graph comparing a value Y of a flat surface of a black base material and a value Y of a mesh embossed surface of a black base material.

FIG. 17 is a graph comparing a value Y of a flat surface of a white base material and a value Y of a woodgrain embossed surface of a white base material.

FIG. 18 is a graph comparing a value Y of a flat surface of a white base material and a value Y of a mesh embossed surface of a white base material.

FIG. 19 is a graph comparing a value Y of a flat surface of a silver base material and a value Y of a woodgrain embossed surface of a silver base material.

FIG. 20 is a graph comparing a value Y of a flat surface of a silver base material and a value Y of a mesh embossed surface of a silver base material.

### DESCRIPTION OF EMBODIMENTS

Embodiments of the present invention will now be described with reference to the drawings. The following description of preferred embodiments is only an example in nature, and is not intended to limit the scope, applications or use of the present invention.

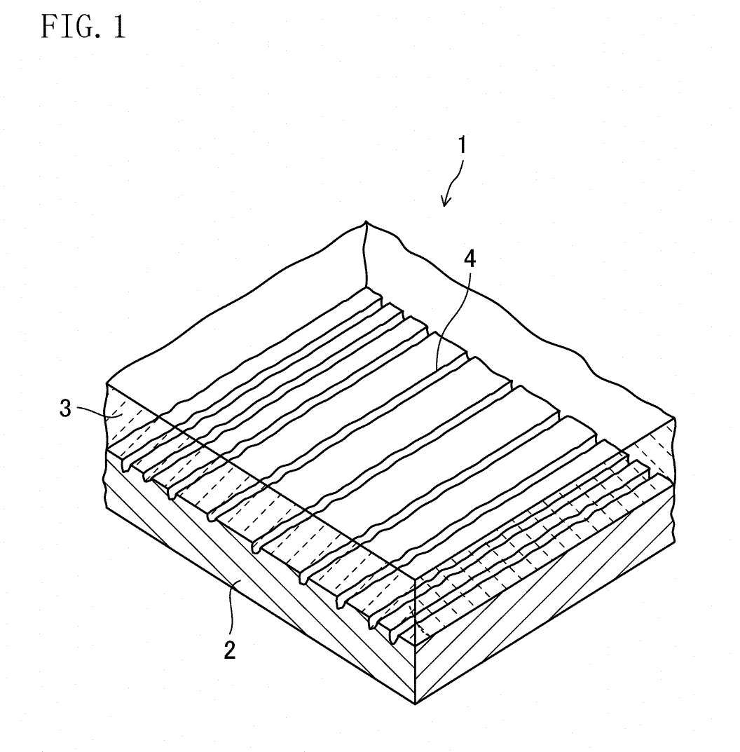

A resin molding 1 shown in FIG. 1 has a base material 2, and a surface layer 3 covering a surface of the base material 2. Embossment 4 is provided for an interface between the base material 2 and the surface layer 3. The surface layer 3 is made of a translucent resin material, and thus, allows the embossment 4 at the interface to be seen through the surface layer 3. The base material 2 is made of a resin material containing a brightening material and/or an inorganic pigment. The surface layer 3 is made of a resin material containing a coloring agent or a resin material containing no coloring agent.

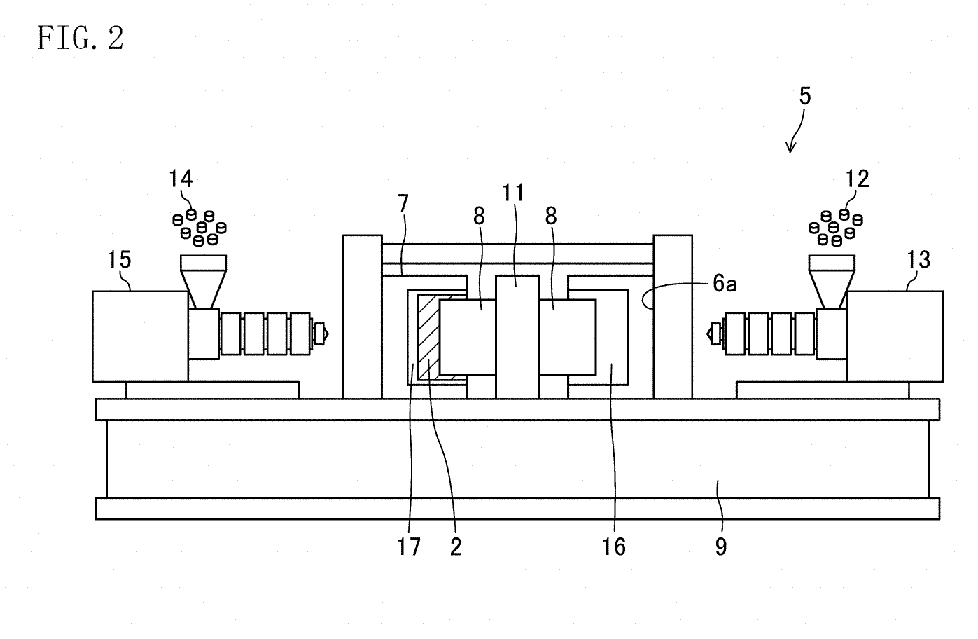

FIG. 2 schematically illustrates an example of an injection molding machine 5 used for manufacturing the resin molding 1. The injection molding machine 5 produces the resin molding 1 by co-injection molding.

The injection molding machine 5 includes a primary cavity mold 6 for molding the base material 2, a secondary cavity mold 7 for molding the surface layer 3, and a pair of core molds 8 used in common for the cavity molds 6 and 7. The cavity molds 6 and 7 are placed on a base 9 to face each other with the core molds 8 interposed therebetween, and are movable in a direction away from each other (mold opening direction). The paired core molds 8 are supported on a rotary 11 which rotates about a vertical axis, and are positioned at 180 degrees with respect to each other.

A first injection unit 13 for injecting a first resin material 12 for molding the base material is disposed behind the primary cavity mold 6. A second injection unit 15 for injecting a second resin material 14 for molding the surface layer is disposed behind the secondary cavity mold 7. The injection units 13 and 15 are movable back and forth with respect to the cavity molds 6 and 7.

The primary cavity mold 6 and one of the core molds 8 form a first molding cavity 16 for molding the base material 2. When the first injection unit 13 moves forward to inject the first resin material 12 in a molten state in the first molding cavity 16, the base material 2 is formed. After the mold is opened, the rotary 11 rotates the pair of core molds 8 180 degrees together with the base material 2, and the mold is closed. Then, a second molding cavity 17 for molding the surface layer 3 is formed between a surface of the base material 2 and the secondary cavity mold 7. When the second injection unit 15 moves forward to inject the second resin material 14 in a molten state in the second molding cavity 17, the surface layer 3 covering the surface of the base material 2 is formed. In a preferred embodiment, a temperature for melting the second resin material is lower than a temperature for melting the first resin material.

If PC is used as a matrix resin of each of the base material 2 and the surface layer 3, for example, a mold temperature may be set to be about 80° C., and a cylinder temperature of the injection units 13 and 15 may be set to be about 250° C., for example, for injection molding the base material 2 and the surface layer 3.

A cavity surface 6a of the primary cavity mold 6, on which the surface of the base material is molded, is grained. The grained cavity surface 6a provides the surface of the base material 2 with the embossment 4. When the surface layer 3 covers the surface of the base material 2 having the embossment 4, the resin molding 1 in which the embossment is provided for an interface between the base material 2 and the surface layer 3 is obtained.

### <Value Y of Base Material>

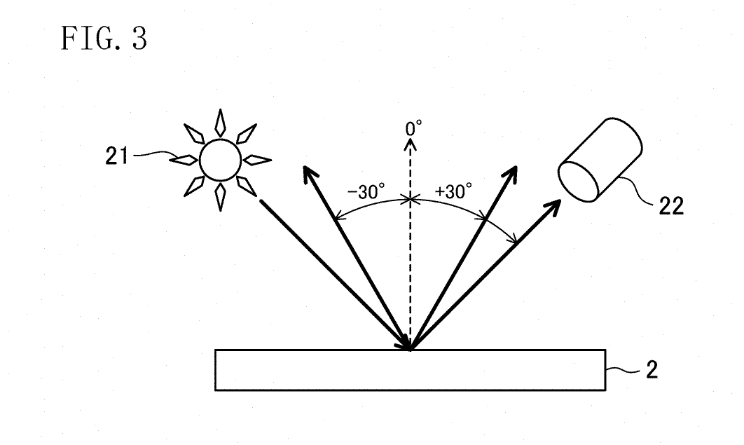

In this embodiment, on a flat portion of the surface of the base material 2 with no embossment 4, a difference between a value Y-highlight and a value Y-shade is 5 or more. The value Y is a value calibrated with a value Y of a white reflectance standard of the XYZ colorimetric system regarded as 100%, and is measured as shown in FIG. 3. Light from a light source 21 is incident on the base material 2 at 45 degrees. An acceptance angle of a sensor 22 is measured with respect to a vertical direction (this direction will be hereinafter referred to as “face”) regarded as 0 degree. The “value Y-highlight” is a value Y of reflected light measured at an acceptance angle of +30 degrees, and the “value Y-shade” is a value Y of reflected light measured at an acceptance angle of −30 degrees.

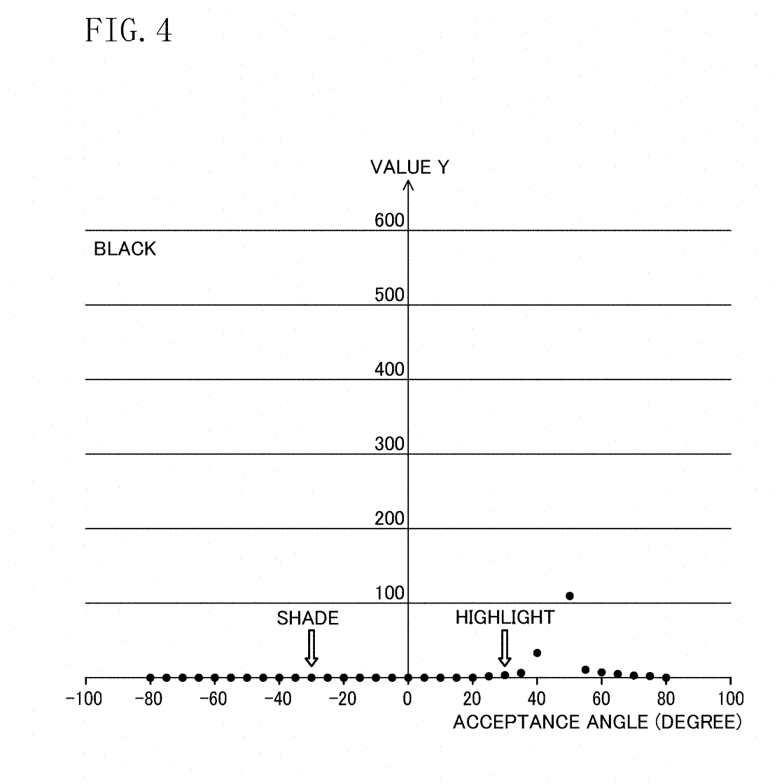

Test pieces of various base materials (black, white, silver, and gunmetal) containing different coloring agents (a pigment or an inorganic pigment) were prepared, and their values Y were measured. For the measurement, a gonio-spectrophotometric color measurement system GCMS-4 manufactured by Murakami Color Research Laboratory Co., Ltd. was used. FIGS. 4-7 are graphs illustrating the measurement results (values Y that vary depending on the acceptance angle).

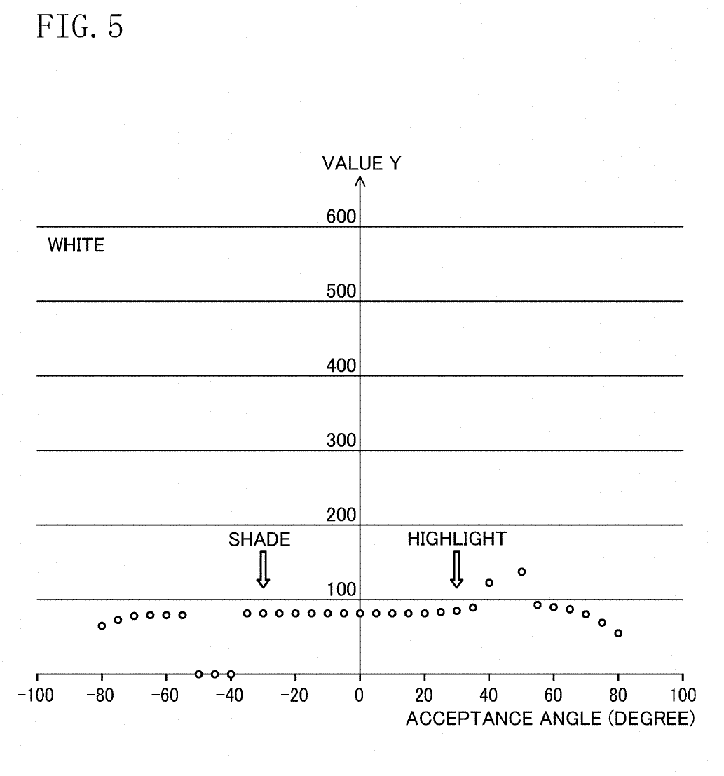

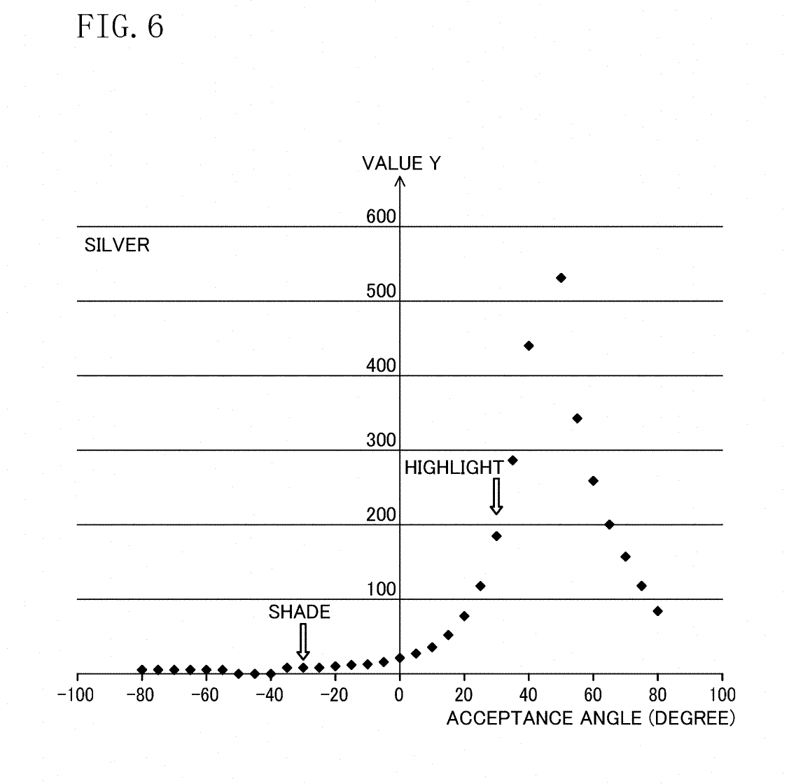

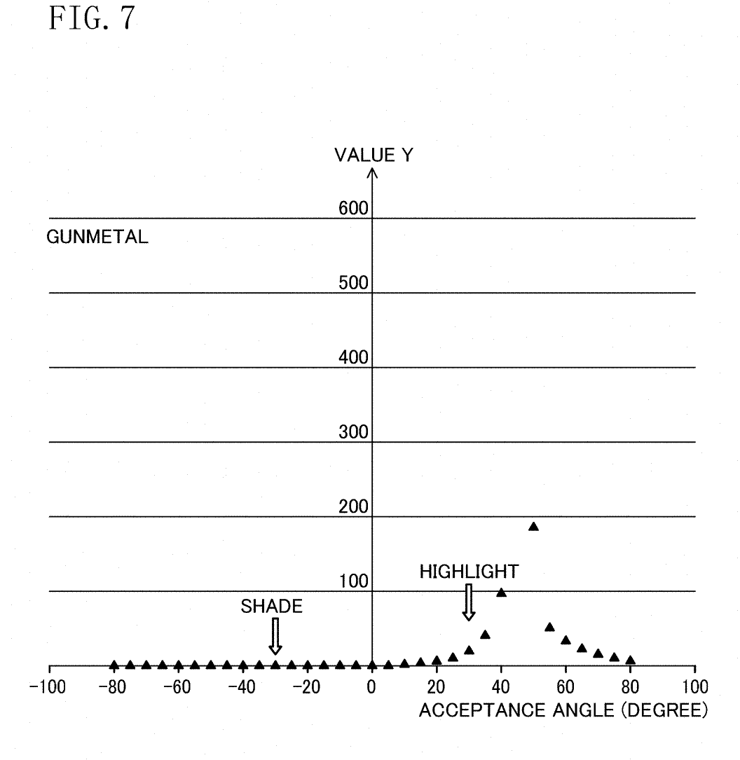

The black base material shown in FIG. 4 contained carbon (concentration: 3 parts) as the coloring agent. The white base material shown in FIG. 5 contained a white pigment (concentration: 3 parts) as the coloring agent. The silver base material shown in FIG. 6 contained aluminum flakes (concentration: 3 parts) as the coloring agent. The gunmetal base material shown in FIG. 7 contained aluminum flakes (concentration: 1 part) and a gunmetal pigment (concentration: 0.5 part) as the coloring agents. PC was used as a matrix resin of each base material. The concentration of each coloring agent is represented in mass ratio relative to 100 parts of the matrix resin.

Table 1 shows a value Y-face (a value Y of light reflected from the flat portion and measured at an acceptance angle of 0 degree), and a difference between the value Y-highlight and the value Y-shade of each of the four base materials.

TABLE 1

| Base material | Black | White | Silver | Gunmetal |
|---|---|---|---|---|
| Difference between value | 3.7 | 3.7 | 175 | 21.8 |
| Y-highlight and value Y-shade | | | | |
| Value Y-face | 0.16 | 81 | 20 | 2.43 |

### <Evaluation of Resin Molding>

Samples 1-8 of the resin molding shown in Table 2 were prepared. Each of Samples 1-8 adopted one of the black, white, silver, or gunmetal base material shown in Table 1, and a red surface layer having a total light transmittance according to JIS K 7361 of 10% or 15%, or a colorless (containing no coloring agent) surface layer having a total light transmittance of 88%. PC was used as a matrix resin of each of the surface layers. The total light transmittance of the surface layer was measured using Haze Meter NDH2000 manufactured by NIPPON DENSHOKU.

In each sample, the embossment at the interface was woodgrain with an emboss height of 55 μm, and the surface layer had a thickness of 15 mm. Each resin molding was visually evaluated on four scales (A: great, B: less great, C: poor, and D: almost zero) in terms of a color depth, shading, and a spatial depth (three-dimensional look). Table 2 shows the results.

TABLE 2

| Resin molding | Sample 1 | Sample 2 | Sample 3 | Sample 4 | Sample 5 | Sample 6 | Sample 7 | Sample 8 |
|---|---|---|---|---|---|---|---|---|
| Hue of surface layer | Red | Red | Red | Red | Red | Colorless | Colorless | Colorless |
| Total light transmittance of surface layer | 15% | 15% | 15% | 15% | 10% | 88% | 88% | 88% |
| Hue of base material | Black | White | Silver | Gunmetal | Silver | Black | White | Silver |
| Difference between value Y-highlight and | 3.7 | 3.7 | 175 | 21.8 | 175 | 3.7 | 3.7 | 175 |
| value Y-shade of base material | | | | | | | | |
| Value Y-face of base material | 0.16 | 81 | 20 | 2.43 | 20 | 0.16 | 81 | 20 |
| Color depth | D | C | B | A | A | D | D | D |
| Shading | D | D | A | B | A | D | D | D |
| Spatial depth | D | C | A | B | A | D | C | B |

A: great,
B: less great,
C: poor,
D: almost zero

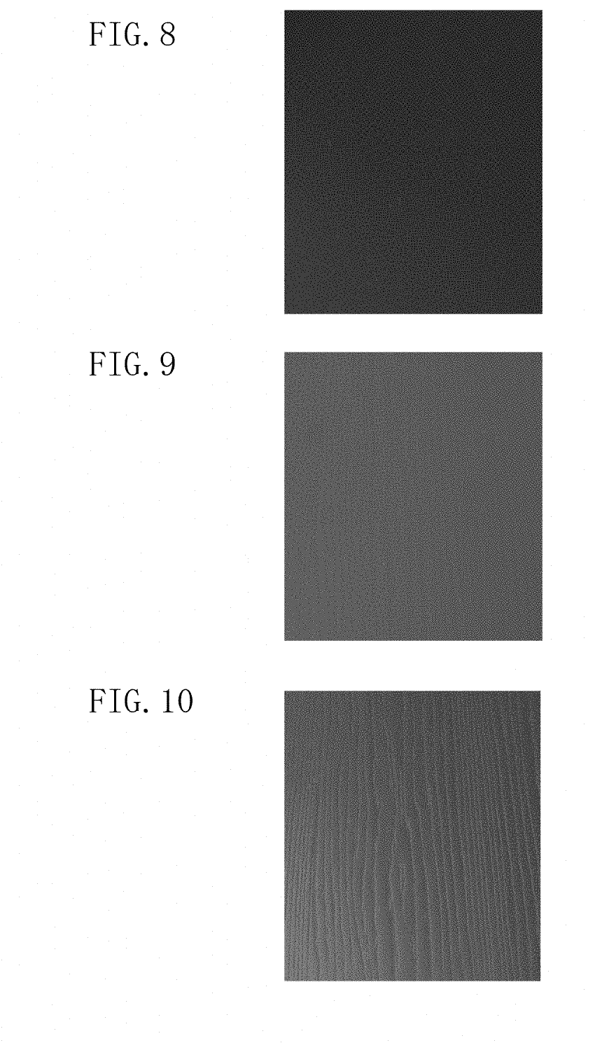

FIG. 8 is an image of the embossment seen through the surface layer of Sample 1 (base material: black, a difference between the values Y of the base material (value Y-highlight−value Y-shade): 3.7). The color depth, the shading, and the spatial depth (three-dimensional look) were hardly observed. FIG. 9 is an image of the embossment seen through the surface layer of Sample 2 (base material: white. the difference between the values Y of the base material: 3.7). The color depth and the spatial depth (three-dimensional look) were poor, and the shading was hardly observed. FIG. 10 is an image of the embossment seen through the surface layer of Sample 3 (base material: silver, the difference between the values Y of the base material: 175). The image shows that the color depth, the shading, and the spatial depth (three-dimensional look) were great.

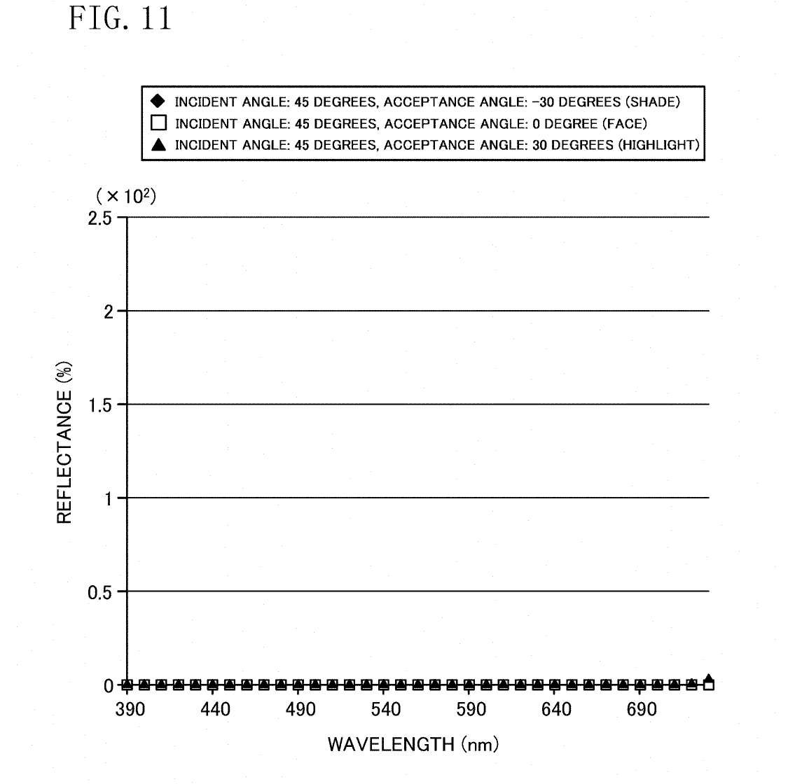

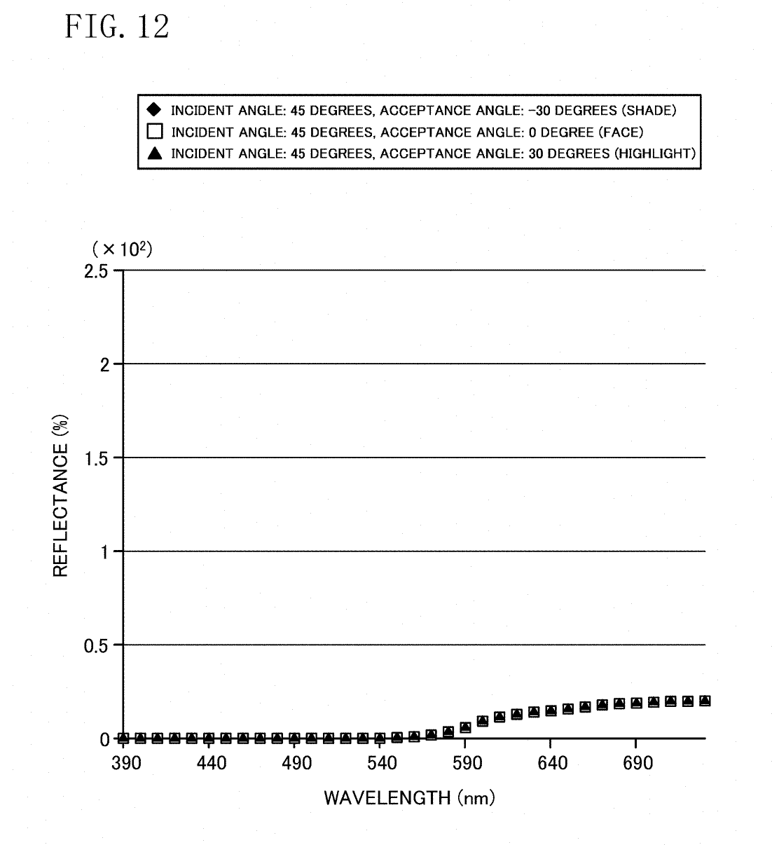

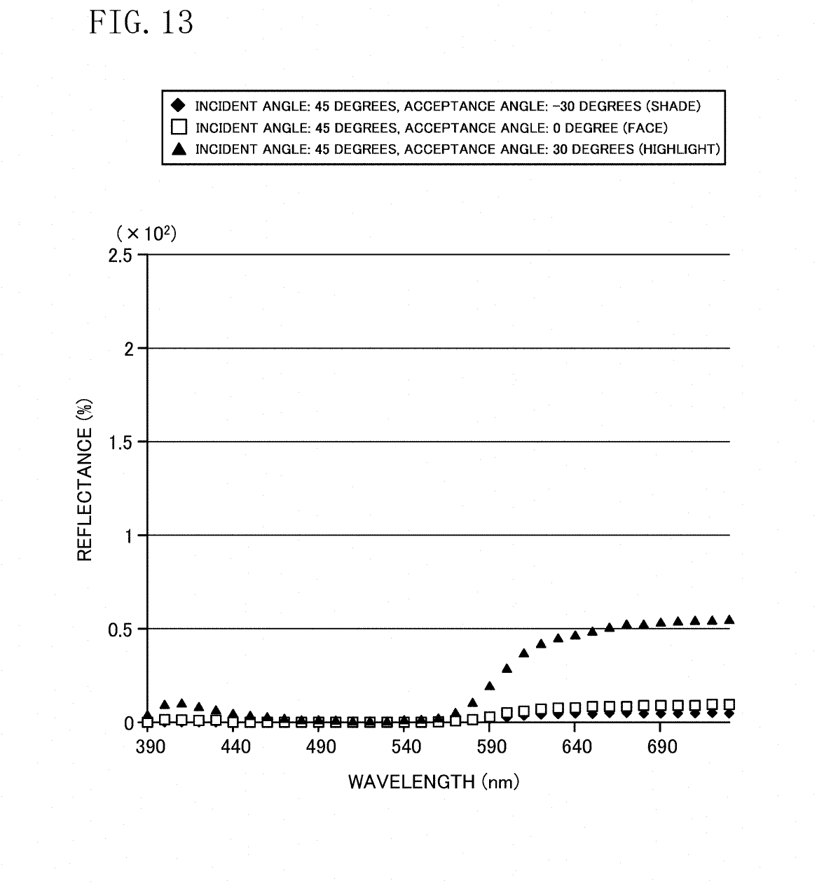

FIGS. 11-13 illustrate spectral reflectance of each of Samples 1-3 (with a surface layer). Regarding Sample 1, reflectances in a highlight direction (incident angle: 45 degrees, acceptance angle: +30 degrees), a shade direction (incident angle: 45 degrees, acceptance angle: −30 degrees), and a face direction (incident angle: 45 degrees, acceptance angle: 0 degree) were almost zero over the entire visible light range (390 to 730 nm). Sample 2 showed the reflectances in the highlight, shade, and face directions risen in a range from around 580 nm to red wavelengths, but they were low.

In contrast, Sample 3 showed the reflectances in the shade and face directions risen in a range from around 580 nm to the red wavelengths, but the rise was low. On the other hand, the reflectance in the highlight direction showed a great rise in the red wavelengths, indicating that the color depth and the shading were great. The difference between the reflectance in the highlight direction and the reflectance in the face direction, and the difference between the reflectance in the highlight direction and the reflectance in the shade direction at a wavelength of 690 nm were within a range from 30% or more to 60% or less.

The reflectances in the highlight, shade, and face directions were calibrated with a reflectance of a white reflectance standard regarded as 100%, and measured using gonio-spectrophotometric color measurement system GCMS-4 manufactured by Murakami Color Research Laboratory Co., Ltd.

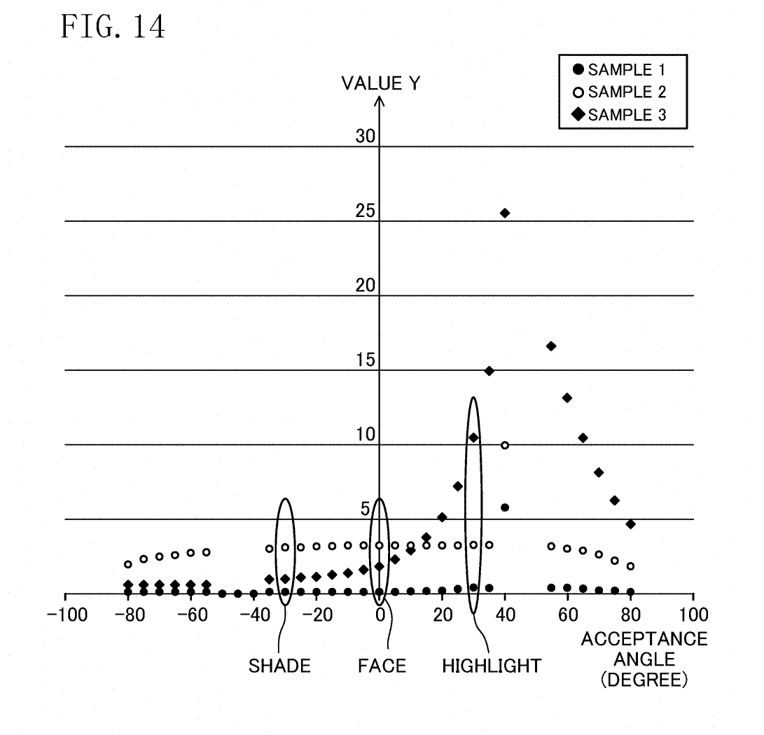

FIG. 14 illustrates a relationship between the acceptance angle and a value Y (not of the flat portion of the surface of the base material, but of the resin molding) of each of Samples 1-3. Regarding Samples 1 and 2, the values Y-highlight, Y-shade, and Y-face were almost equal. In Sample 3, the value Y increased in the order of the values Y-shade, Y-face, and Y-highlight, i.e., the value Y measured closer to the regular reflection direction was greater. Regarding Sample 3, the difference between the value Y-highlight and the value Y-face was in a range from 6 or more to 10 or less. The difference between the value Y-face and the value Y-shade was in a range from 0.5 or more to 1.5 or less. The values Y were measured using a gonio-spectrophotometric color measurement system GCMS-4 manufactured by Murakami Color Research Laboratory Co., Ltd.

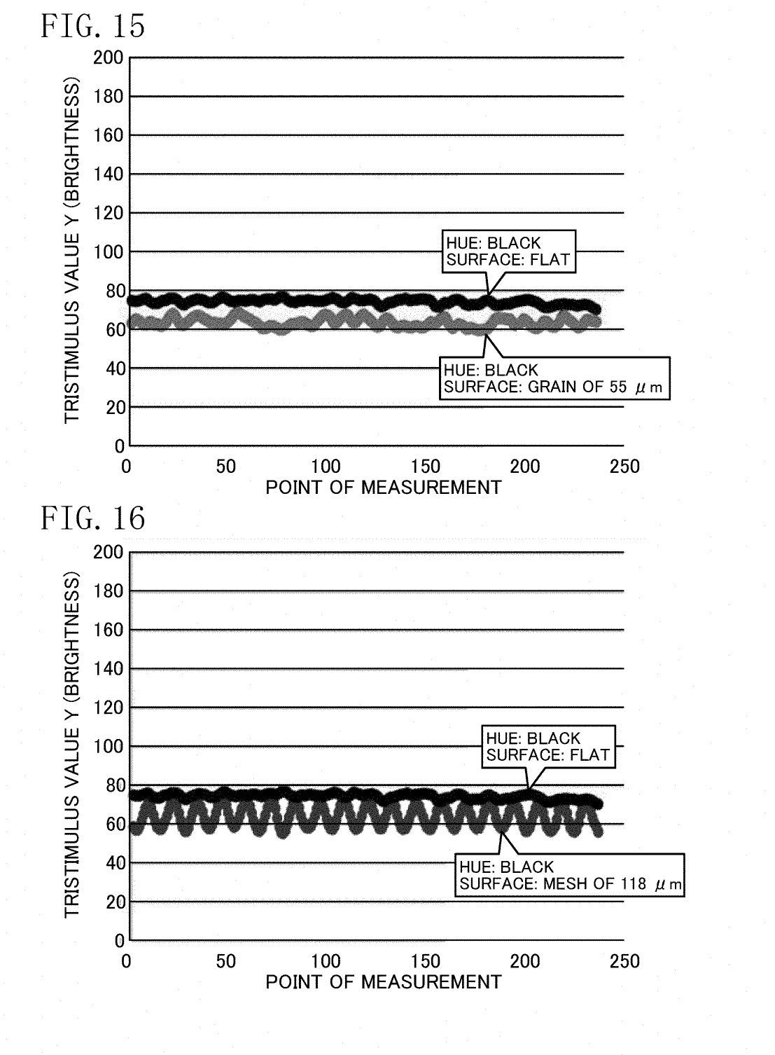

FIGS. 15-20 are graphs each showing the results of comparison between the value Y of a base material with a flat surface and the value Y of a base material with an embossed surface. The comparison is carried out to examine the influence of the difference in hue (black, white, and silver) and the difference in embossment (woodgrain (emboss height: 55 μm) and mesh (emboss height: 118 μm) on the value Y of the base material. The values Y were measured using a 2D luminance colorimeter UA-200 of Topcon Technohouse Corporation. A unit of the horizontal axis of each of the graphs of FIGS. 15-20 is a pixel.

As shown in FIGS. 15 and 16, when the hue was black, the difference in value Y between the flat base material and the embossed base material was small, irrespective of whether the embossment was woodgrain or mesh. This indicates that, in this case, the embossment was not greatly emphasized when observed through the surface layer.

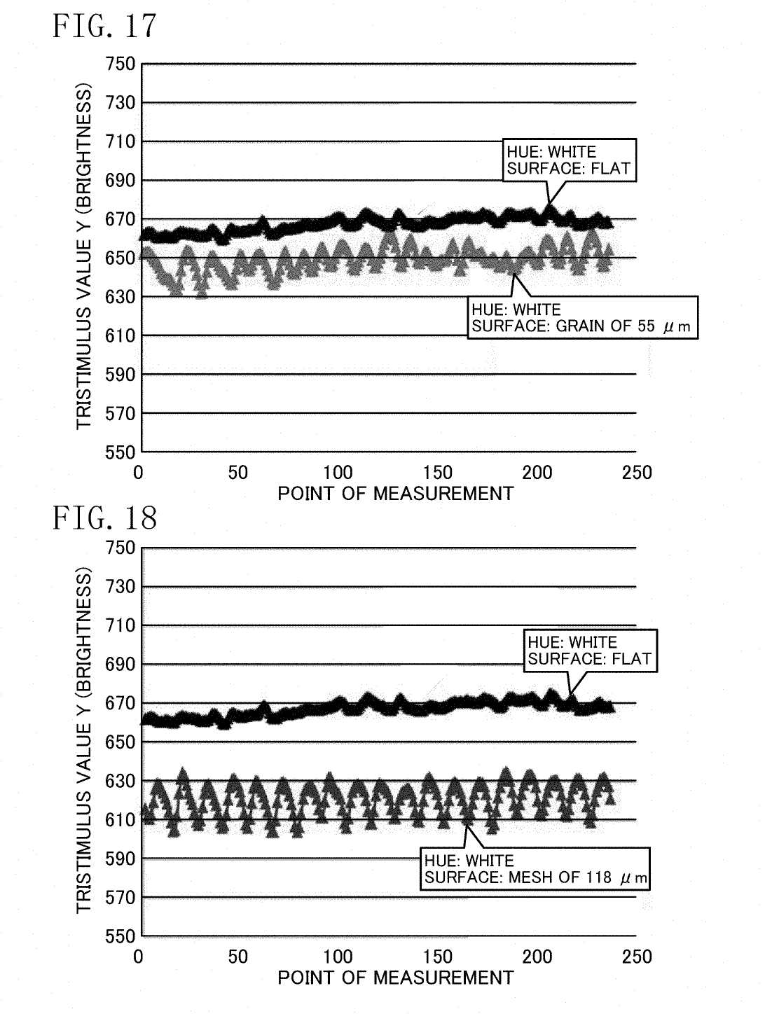

As shown in FIGS. 17 and 18, when the hue was white, the difference in value Y between the flat base material and the embossed base material became greater, but the amplitude of the value Y caused by the embossment did not greatly increase, as compared with the case where the hue was black. This indicates that the embossment was not greatly emphasized when observed through the surface layer.

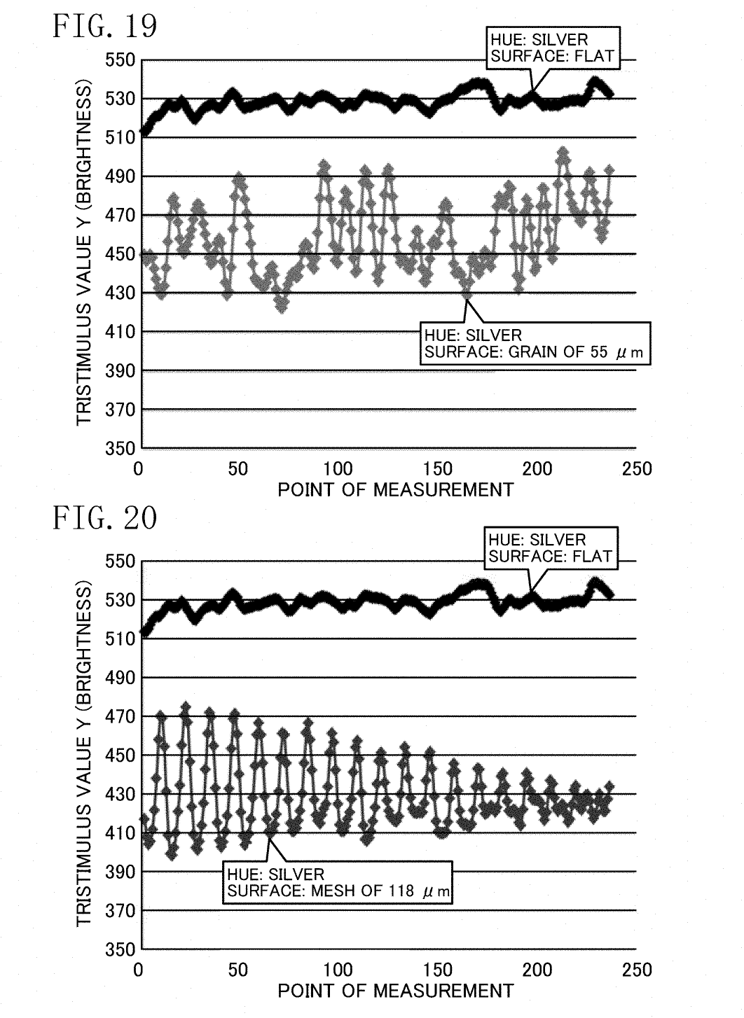

In contrast, as shown in FIGS. 19 and 20, when the hue was silver, the difference in value Y between the flat base material and the embossed base material increased (difference between mean values of the values Y was 50 or more), and the amplitude of the value Y caused by the embossment also increased. This indicates that the embossment was emphasized when observed through the surface layer.

### DESCRIPTION OF REFERENCE CHARACTERS

1 Resin Molding
2 Base Material
3 Surface layer
4 Embossment
5 Injection Molding Machine
6 Primary Cavity Mold
7 Secondary Cavity Mold
8 Core Mold
12 First Resin Material
14 Second Resin Material
16 First Molding Cavity
17 Second Molding Cavity

1. A resin molding comprising: a base material; and a translucent surface layer which covers a surface of the base material, wherein
embossment is provided for an interface between the base material and the surface layer,
if a value Y-highlight designates a value Y of light which is incident at 45 degrees and detected at an acceptance angle of +30 degrees, and a value Y-shade designates a value Y of light which is incident at 45 degrees and detected at an acceptance angle of −30 degrees, the value Y-highlight and the value Y-shade being calibrated with a value Y of a white reflectance standard of an XYZ colorimetric system regarded as 100%, a difference between the value Y-highlight and the value Y-shade of a flat portion of the surface of the base material is 5 or more, and
the surface layer has a total light transmittance of 2.5% or more and 60% or less.

2. The resin molding of claim 1, wherein
the embossment has an emboss height of 5 μm or more and 700 μm or less.

3. The resin molding of claim 1, wherein
the surface layer has a thickness of 0.8 mm or more and 8 mm or less.

4. The resin molding of claim 1, wherein
the surface layer contains a coloring agent.

5. The resin molding of claim 1, wherein
the difference between the value Y-highlight and the value Y-shade is 10 or more.

6. The resin molding of claim 1, wherein
the surface layer has a total light transmittance of 5% or more and 50% or less.

7. A method for manufacturing the resin molding of claim 1, the method comprising:
injecting a first resin material in a first molding cavity having a grained molding surface for forming the embossment, thereby forming one of the base material having the embossment corresponding to the grained surface or the surface layer having the embossment corresponding to the grained surface;
forming a second molding cavity on a surface of the base material provided with the embossment or a surface of the surface layer provided with the embossment; and
injecting a second resin material in the second molding cavity to form the other one of the base material or the surface layer.

8. The method of claim 7, wherein
the first resin material contains a brightening material and/or an inorganic pigment, and is injected in the first molding cavity to form the base material having on its surface the embossment corresponding to the grained surface, and
the second resin material is injected in the second molding cavity to form the surface layer.

9. The method of claim 8, wherein
the surface layer molded from the second resin material has a thickness of 0.8 mm or more and 8 mm or less or less.

10. The method of claim 8, wherein
the embossment provided for the surface of the base material has an emboss height of 700 μm or less.

11. The resin molding of claim 1, wherein
the difference between the value Y-highlight and the value Y-shade is 15 or more and 400 or less.

12. The resin molding of claim 1, wherein
the surface layer has a total light transmittance of 8% or more and 40% or less.

13. The resin molding of claim 8, wherein
the embossment provided for the surface of the base material has an emboss height of 5 μm or more and 700 μm or less.
